(19) United States
(12) Patent Application Publication
(10) Pub. No.: US 2020/0281181 A1
(43) Pub. Date: Sep. 10, 2020

(54) Bug Zapper Coil Sweeper

(71) Applicant: Howard Flowers, Merigold, MS (US)

(72) Inventor: Howard Flowers, Merigold, MS (US)

(21) Appl. No.: 16/665,492

(22) Filed: Oct. 28, 2019

Related U.S. Application Data
(60) Provisional application No. 62/813,220, filed on Mar. 4, 2019.

(51) Int. Cl. A01M 1/22; B08B 1/00; A46B 5/00

(52) U.S. Cl. CPC A01M 1/223; A46B 2200/3073; A46B 5/00; B08B 1/002

(57) ABSTRACT

A bug zapper coil cleaner including a brush element that is non-conductive. At least one handle is attached to the brush element. The at least one handle member is configured to move the brush from the outside of the housing on a bug zapper. The at least one handle has an elongated attachment member protruding from one end. Further, there is a clasp member connected to the brush element. The clasp member is a magnetic clasp. The clasp will hold the bug zapper coil cleaner at the top of the bug zapper between uses.

### CROSS REFERENCE TO RELATED APPLICATIONS

This application claims the benefit of U.S. Provisional Application No. 62/813,220 filed on Mar. 4, 2019. The above identified patent application is herein incorporated by reference in its entirety to provide continuity of disclosure.

### BACKGROUND OF THE INVENTION

The present invention relates to bug zappers and cleaning the same. More particularly, the present invention provides a cleaner that will allow a bug zapper to be cleaned without disassembly.

People all over the world can appreciate the annoyance of insects that bite individuals to eat. While this is a process of life, the results can be annoying, at the very least. Insects, such as mosquitos, can carry diseases and cause a mass infection if not minimized. At the very least, bites from such insects leave itchy welts on the unsuspecting victim. Due to the results of mosquito and other insect bites, many solutions have been invented to dispense of such bugs. One of these inventions is an electric bug zapper.

Bug zappers have proven to be effective in reducing mosquito numbers. Bug zappers have a major drawback, however. Currently, in order to clean a bug zapper, the zapper will need to be powered down and disassembled. This means that cleaning a bug zapper is a time-consuming process. Further, while the zapper is being cleaned it is not operational.

Consequently, there is a need in for an improvement in the art of cleaning bug zappers. The present invention substantially diverges in design elements from the known art while at the same time solves a problem many people face when cleaning bug zappers. In this regard the present invention substantially fulfills these needs.

### SUMMARY OF THE INVENTION

The present invention provides a bug zapper coil sweeper wherein the same can be utilized for providing convenience for the cleaning a bug zapper. The bug zapper coil cleaner includes a brush element configured to be placed against a zapper coil. At least one handle member is attached to the brush element. The at least one handle member has an elongated attachment member.

Another objection of the bug zapper coil cleaner is that the brush element is non-conductive.

Another objection of the bug zapper coil cleaner is that the brush element is comprised of bristles.

Another objection of the bug zapper coil cleaner is that the brush element is comprised of a single element.

Another objection of the bug zapper coil cleaner is that a clasp attached to the brush element.

Another objection of the bug zapper coil cleaner is that the clasp is the first end of a magnetic clasp.

Another objection of the bug zapper coil cleaner is that the second end of the magnetic clasp is configured to attach to the top of a bug zapper.

Another objection of the bug zapper coil cleaner is that the brush element is rectangular.

Another objection of the bug zapper coil cleaner is that the brush element is circular.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the bug zapper coil cleaner and a bug zapper.

FIG. 2 shows a perspective view of an embodiment of the bug zapper coil cleaner installed in a bug zapper.

FIG. 3 shows a perspective view of an embodiment of the bug zapper coil cleaner wherein the cleaner is rectangular.

FIG. 4 shows a perspective view of an embodiment of the bug zapper coil cleaner wherein the cleaner is circular.

FIG. 5 shows a perspective view of an embodiment of the bug zapper coil cleaner wherein the cleaner is a single article.

### DETAILED DESCRIPTION OF THE INVENTION

Reference is made herein to the attached drawings. Like reference numerals are used throughout the drawings to depict like or similar elements of the bug zapper coil sweeper. For the purposes of presenting a brief and clear description of the present invention, a preferred embodiment will be discussed as used for the bug zapper coil sweeper. The figures are intended for representative purposes only and should not be considered to be limiting in any respect.

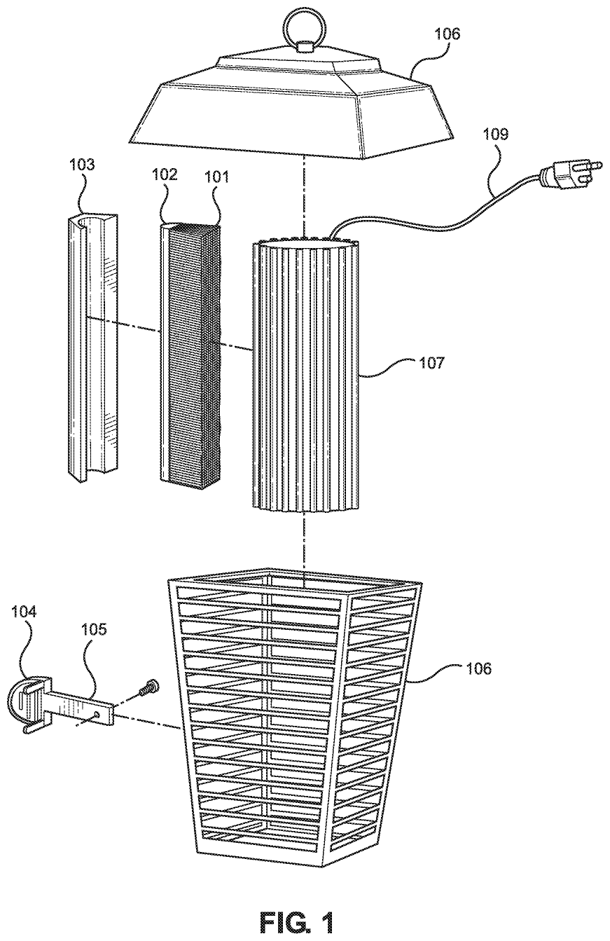

Referring now to FIG. 1, there is shown an exploded view of an embodiment of the bug zapper coil cleaner and a bug zapper. The bug zapper coiler cleaner is comprised of a brush element 101. In one embodiment, the brush element 101 is comprised of a plurality of bristles attached to a bar 102. In one embodiment, the brush element 101 is made from a non-conductive material. In one embodiment, where the bristles of the brush element 101 are attached to the bar 102, there is a bar cover 103. The bar cover 103 will cover the bar and protect the metallic element of the bar 102.

There is at least one handle member 104 attached to an elongated member 105. The elongated member 105 is attached to the handle such that the elongated member 105 will stick into the zapper and the handle member 104 will protrude on the exterior of the zapper. This will allow a user to operate the bug zapper coil sweeper from the exterior of the cage. The elongated member 105 can be a variety of lengths. The varying lengths of the elongated member 105 will ensure that the brush element 101 will always be pressed against the zapper coils 107. The handle members 104 are attached to the bar 102, this attached the handle members 104 to, the brush element 101. The handle member 104 is configured to move the brush element 101. In one embodiment, the handle member 104 is made from a non-conductive material.

Traditionally, bug zappers are made up of at least a few common elements. A bug zapper has a housing 106 to support the parts of a bug zapper. The bug zapper has a power source 109. In one embodiment, the power source 105 is a battery. In another embodiment, the power source 109 is a power cord. The power source 105 is connected to a plurality of electric or zapper coils 107. The zapper coils 107 are exposed such that bugs are killed on contact. A cage 108 is placed around the zapper coils 107 such that a human cannot accidentally touch the zapper coils 107 and become electrocuted.

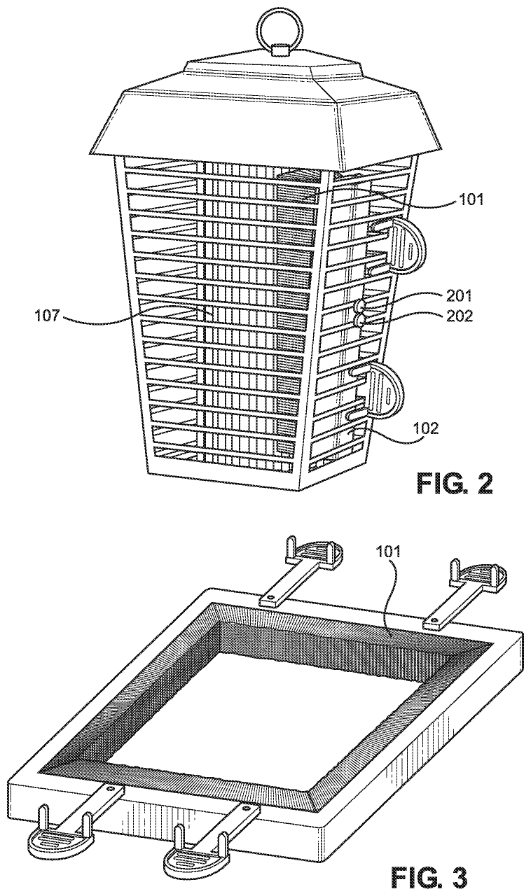

Referring now to FIG. 2, there is shown a perspective view of an embodiment of the bug zapper coil cleaner installed in a bug zapper. In one embodiment, the bug zapper coil cleaner is installed on one side of the bug zapper. In this embodiment, the bug zapper coil cleaner is pressed up against the zapper coils 107 of the bug zapper. This will allow the brush element 101 to clean the insects off of the zapper coils 107. In an embodiment there is a clasp 201, 202 which will hold the bug zapper cleaner in place when not in use. In one embodiment, there is a first part of a clasp 201 attached to the bug zapper coil cleaner. The first part of the clasp is attached to the bar 102. A second part of the clasp 202 is attached to the bug zapper cage 108. The first part of the clasp 201 connects to the second part of the clasp 202 and holds the bug zapper coil cleaner is a storage position until it is ready to be used. In one embodiment the clasp 201, 202 is a magnetic clasp. In another embodiment, the clasp 201, 202 is a hook and loop clasp.

Referring now to FIG. 3, there is shown a perspective view of an embodiment of the bug zapper coil cleaner wherein the cleaner is rectangular. In one embodiment, the bug zapper coil cleaner is rectangular is shape. Bug zappers commonly come in rectangular shape. This shape will have four sides connected at the corners. In this embodiment, the brush element 101 will be configured to rest on all four sides of a rectangular bug zapper at one time. In this embodiment, a rectangular bug zapper can be cleaned in one pass of the bug zapper coil sweeper.

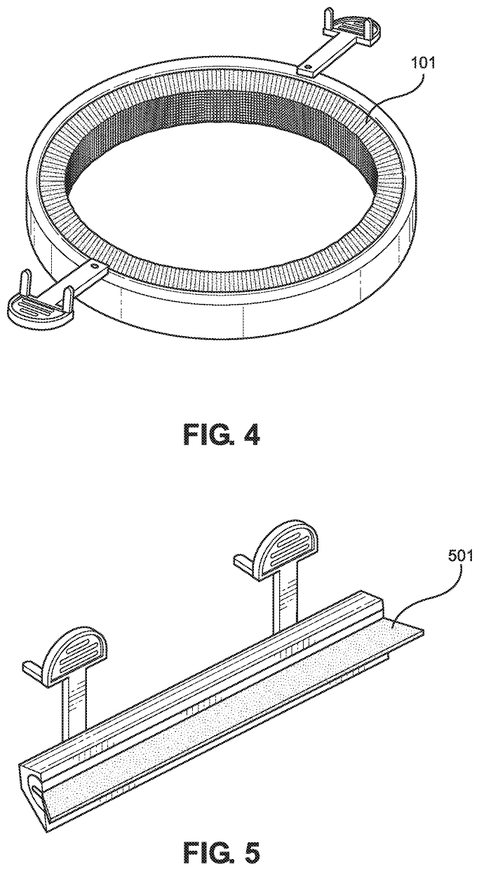

Referring now to FIG. 4, there is shown a perspective view of an embodiment of the bug zapper coil cleaner wherein the cleaner is circular. In one embodiment, the bug zapper coil sweeper can be in a circular shape. Bug zappers can come in circular configuration this means that the coils in a bug zapper are circular. In the embodiment where the bug zapper coil cleaner is circular, the brush element 101 is designed to fit on the entire 360 degrees of the coils. This will allow for easy cleaning of a circular bug zapper.

Referring now to FIG. 5, there is shown a perspective view of an embodiment of the bug zapper coil cleaner wherein the cleaner is a single article. In one embodiment of the bug zapper coil cleaner, the brush element 501 is comprised of a single part. This single part will be similar to a window squeegee. In this element the brush element 501 does not contain bristles. In one embodiment, the brush element 501 is a single wiper. In one embodiment, the wiper is made from rubber. In one embodiment, the material is non-conductive.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A bug zapper coil cleaner including:
a brush element configured to be placed against a zapper coil;
at least one handle member attached to the brush element;
wherein the at least one handle member has an elongated attachment member that attached the handle member to the brush element.

2) The bug zapper coil cleaner of claim 1, wherein the brush element made from a non-conductive material.

3) The bug zapper coil cleaner of claim 1, wherein the brush element is comprised of bristles.

4) The bug zapper coil cleaner of claim 1, wherein the brush element is comprised of a single element.

5) The bug zapper coil cleaner of claim 1 further includes a clasp attached to the brush element.

6) The bug zapper coil cleaner of claim 5, wherein the clasp is the first end of a magnetic clasp.

7) The bug zapper coil cleaner of claim 6, wherein the second end of the magnetic clasp is configured to attach to the top of a bug zapper.

8) The bug zapper coil cleaner of claim 1, wherein the brush element is rectangular.

9) The bug zapper coil cleaner of claim 1, wherein the brush element is circular.

10) An electric bug zapper including:
a bug zapper having an electric core within a housing;
the housing including a wire cage and a top section;
a brush element configured to be placed against a zapper coil;
at least one handle member attached to the brush element;
the at least one handle member has an elongated attachment member.

11) The bug zapper of claim 10, wherein the brush element is non-conductive.

12) The bug zapper of claim 10, wherein the brush element is comprised of bristles.

13) The bug zapper of claim 10, wherein the brush element is comprised of a single element.

14) The bug zapper of claim 10 further includes a clasp attached to the brush element.

15) The bug zapper of claim 14, wherein the clasp is the first end of a magnetic clasp.

16) The bug zapper of claim 15, wherein the second end of the magnetic clasp is attached to the top of a bug zapper.

17) The bug zapper of claim 10, wherein the bug zapper is rectangular.

18) The bug zapper of claim 17, wherein the brush element is rectangular.

19) The bug zapper of claim 10, wherein the bug zapper is circular.

20) The bug zapper of claim 19, wherein the brush element is circular.
